(19) United States
(12) Patent Application Publication
(10) Pub. No.: US 2026/0100552 A1
(43) Pub. Date: Apr. 9, 2026

(54) METHOD FOR REDUCING PARASITIC INDUCTANCE OR PARASITIC CAPACITANCE AND APPLICATIONS OF CONDUCTIVE COATING

(71) Applicant: HAO-SHENG Technology Co., Ltd., Taoyuan City (TW)

(72) Inventors: Shi-Wei CHEN, Taoyuan City (TW); Qing-Feng HUANG, Taoyuan City (TW)

(73) Assignee: HAO-SHENG Technology Co., Ltd., Taoyuan City (TW)

(21) Appl. No.: 19/352,122

(22) Filed: Oct. 7, 2025

(30) Foreign Application Priority Data
Oct. 7, 2024 (TW) 113138095

(51) Int. Cl. H01R 43/00

(52) U.S. Cl. CPC H01R 43/00

(57) ABSTRACT

A method of reducing parasitic inductance or parasitic capacitance of the present invention is to apply conductive paint to the contacts where electricity is transmitted. Through the method of the present invention, the parasitic inductance or parasitic capacitance can be reduced, and the operation method is simple, without changing the circuit design or adding any electronic circuit components, and can greatly improve the performance and stability of power transmission.

### FIELD OF THE INVENTION

The present invention relates generally to methods of reducing parasitic inductance or parasitic capacitance, and more particularly, to the application and use of a conductive coating for such purposes.

### BACKGROUND OF THE INVENTION

Parasitic inductance and parasitic capacitance typically occur in electronic circuits and components due to non-ideal physical structures and wiring arrangements. In industrial environments, power wires and cables are routed based on available space and equipment positioning, necessitating multiple bends and contacts before reaching the terminus, as depicted in FIG. 1. These contact points tend to induce parasitic inductance or capacitance during power transmission, adversely impacting circuit and power system performance and stability.

The occurrence of parasitic inductance or capacitance can cause signal reflection and distortion, particularly in high-frequency and high-speed data transmission circuits, where signal rise and fall times are delayed and waveform deformation occurs, impairing signal integrity. These parasitics may also result in increased electromagnetic emissions, causing electromagnetic interference (EMI) to surrounding devices. Furthermore, parasitic reactances increase power loss within the circuit, lowering efficiency and generating unwanted heat that limits performance, as illustrated in FIGS. 1 and 2.

Conventional approaches to suppress parasitic effects include optimized layout, use of low-parasitic components, and the addition of decoupling capacitors. In larger power systems or factory cable configurations, devices such as reactors and power factor correction equipment are often used. However, every connection, junction, and extension introduces new contact points where parasitic phenomena may arise. In an age of energy conservation, developing means to mitigate losses from contact points is of growing importance.

### SUMMARY OF THE INVENTION

Accordingly, it is an object of the present invention to resolve parasitic inductance and parasitic capacitance at contact points, thereby significantly improving performance and stability in power transmission systems without requiring circuit redesign.

The disclosed method involves applying a conductive coating to metallic contact points along the path of power transmission. This straightforward method lowers parasitic effects and obviates the need for extra components or circuit modifications, simplifying design and implementation.

The conductive coating comprises at least one carbon-based polymer material.

The conductive coating may be applied using either a plastic brush or a natural-hair brush, with the natural-hair brush preferred for minimizing frictional static buildup during application.

Application should be performed at room temperature, beginning from the topmost metallic contact point and proceeding downward. All surfaces of the contact exposed to air should be thoroughly coated.

After application, each metallic contact point should possess an adherent conductive coating layer of at least 1 μm thickness.

The conductive coating may be formulated in liquid or paste form.

Another aspect of the invention is the use of the conductive coating for reducing parasitic inductance or capacitance by coating the surface of a metallic contact at room temperature.

The conductive coating applied to the contact surface should have a thickness of between 1μm and 1 mm.

Use of the inventive method and conductive coating leads to improvements in circuit and power transmission performance and stability, including enhanced signal integrity, reduced EMI, minimized voltage overshoot and oscillation, improved power efficiency, and greater design flexibility.

In sum, the invention offers advantages for modern electronic and power transmission devices by increasing system reliability, supporting thermal management, and enabling innovative circuit topologies.

### BRIEF DESCRIPTION OF THE DRAWINGS

FIG. 1 is a schematic diagram of an industrial power distribution system.

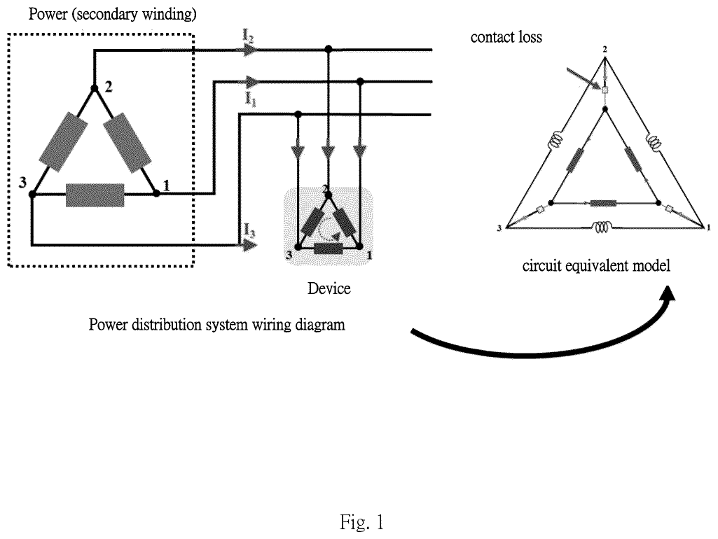

FIG. 2 is a photograph showing oxidation at a contact point.

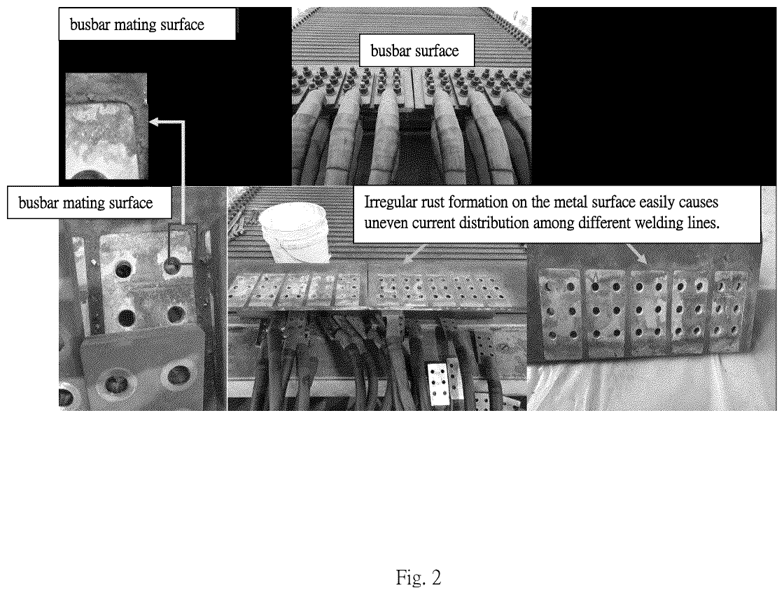

FIG. 3 is a graph showing variation in real power before and after treatment using the inventive method.

### DETAILED DESCRIPTION OF THE INVENTION

In a preferred embodiment, the method for reducing parasitic inductance or parasitic capacitance involves applying the conductive coating to metallic contact points through which electrical power is transmitted. Application of the conductive coating reduces parasitic reactances without changing the design of the circuit or adding extra electronic components, thereby enhancing both performance and stability.

The conductive coating composition includes a conductive organic polymer (examples include conductive polymer, intrinsically conductive polymer (ICP), or polyacetylene), a non-conductive organic compound, and a reducing agent. Carbon-based polymer material may be added. The conductive polymer functions via a conjugated backbone comprised of alternating single and double bonds. The non-conductive organic compound may comprise one or more carbonyl (—C(═O)—) or hydroxyl (—OH) groups as structural units. Representative weight ratios include 10-40% conductive polymer, 50-80% non-conductive compound, and 1-10% reducing agent.

The conductive coating may be applied using a plastic brush, animal-hair brush, or anti-static brush, with preference for animal-hair or anti-static brushes to reduce static interference during application.

Coating should be performed at room temperature (0-50°C), beginning with the uppermost metallic contact and working downward, such that any air-exposed surfaces are fully coated.

In a preferred embodiment, the conductive coating, in liquid or paste form, is deposited to a thickness of 1μm to 1 mm and covers at least 90% of the contact surface area.

Another aspect of the present invention is directed to the use of the conductive coating to reduce parasitic inductance or capacitance by application at room temperature (0-50°C) to metallic contact surfaces.

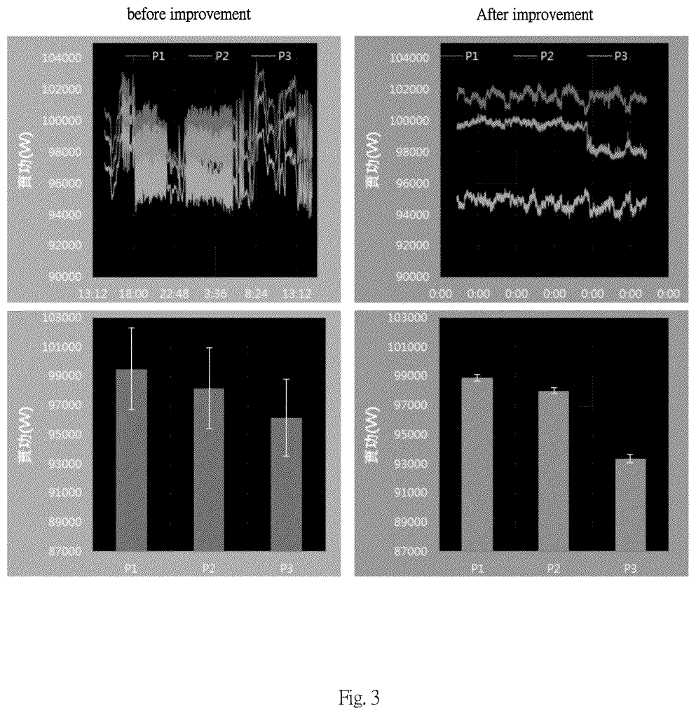

The method effectively reduces interface parasitic inductance and parasitic capacitance, particularly important under high current conditions, thereby mitigating voltage-current phase distortion, signal integrity losses, and power loss. The treatment also imparts waterproofing, helping protect metal contacts in confined applications—such as in solar modules—from rusting due to moisture exposure. As evidenced by the test results in FIG. 3, the treated contacts exhibit markedly stable real power characteristics post-coating, confirming improved system stability and efficiency. In summary, the disclosed method and applications enable control and reduction of parasitic inductance and capacitance, improving system reliability, EMI suppression, power transfer efficiency, and overall design flexibility, which are all vital to advanced electronic and power transmission devices. The method also provides surface energy reduction and temperature isolation at contact interfaces.

### SYMBOLS EXPLANATION

None.

1. A method for reducing parasitic inductance or parasitic capacitance, comprising applying a conductive coating to a metallic contact point along a current path.

2. The method of claim 1, wherein the conductive coating comprises a carbon-based polymer material.

3. The method of claim 1, wherein the conductive coating is applied using a plastic brush or an animal-hair brush.

4. The method of claim 3, wherein the conductive coating is applied at room temperature, beginning from the uppermost metallic contact point and proceeding downward, so that all air-exposed surfaces of the metallic contact are coated.

5. The method of claim 1, wherein a conductive coating layer of at least 1 μm thickness remains adhered to the metallic contact point after application.

6. The method of claim 1, wherein the conductive coating is in liquid or paste form.

7. A use of a conductive coating, comprising applying the conductive coating at room temperature to a surface of a metallic contact point to reduce parasitic inductance or parasitic capacitance.

8. The use of claim 7, wherein the conductive coating is applied to the metallic contact surface at a thickness of 1μm to 1 mm.

9. The use of claim 7, wherein the conductive coating is in liquid or paste form.
